(19) United States
(12) Patent Application Publication
(10) Pub. No.: US 2015/0115548 A1
(43) Pub. Date: Apr. 30, 2015

(54) COMPOSITE GASKET

(71) Applicants: Alfred Fitzgerald Waterland, III, Chesterfield, VA (US); David Aaron Conner, Colonial Heights, VA (US); Kenneth Ryan Grant, Colonial Heights, VA (US); Timothy Meade Heartwell, Chester, VA (US)

(72) Inventors: Alfred Fitzgerald Waterland, III, Chesterfield, VA (US); David Aaron Conner, Colonial Heights, VA (US); Kenneth Ryan Grant, Colonial Heights, VA (US); Timothy Meade Heartwell, Chester, VA (US)

(73) Assignee: VIRGINIA SEALING PRODUCTS, INC., Prince George, VA (US)

(21) Appl. No.: 14/510,181

(22) Filed: Oct. 9, 2014

Related U.S. Application Data
(60) Provisional application No. 61/896,822, filed on Oct. 29, 2013.

(51) Int. Cl. F16J 15/08

(52) U.S. Cl. CPC F16J 15/0806; F16J 15/0825; F16J 2015/0856
USPC 277/654

(57) ABSTRACT

A composite gasket is formed of soft outer facing layers with a harder tanged material sandwiched in between. The soft outer layers allow the gasket to conform to flange irregularities, while also sealing at low bolt loads. The hard core tangs spear into the body of the facing layers during compression thereby allowing the harder tanged core to securely grip into the soft outer facings and provide a durable core throughout the entire body of the gasket.

This application claims the benefit of filing of U.S. Provisional Patent Application Ser. No. 61/896,822, filed Oct. 29, 2013 entitled “LOAD-LOCK GASKET”, which is incorporated herein by reference in its entirety.

The field of the invention is gaskets that are engineered for use with flanges that have high internal pressure requirements. Specifically, the gasket described herein is formed of composite gasket materials that include a tanged core.

### BACKGROUND

The expression “blow out” is a term used to describe a common internal failure in a bolted flange connection. A blow out occurs when the external load (bolt load) on a joint falls to a point below or near the hydrostatic end force created by the internal pressure acting against the contained area of the joint. At this point, the separating force inside the connection becomes greater than the closure force on the bolted joint connection causing a catastrophic failure. The joint then separates or ruptures thus completely losing the gasket seal. Blow outs can cause dangerous high pressure and service fluid releases. Selecting the correct gasket, and developing and maintaining appropriate bolt preloads are the only way to avoid a possible flow out in many applications. There is a much higher blow out potential when installing a gasket that has high relaxation properties. When a gasket relaxes after being installed, the bolt load on the joint is greatly reduced. If this load falls below the internal pressure, a failure can occur in the system.

The gasket is a critical component in having a safe and reliable bolted flange connection. In the gasket industry, there are two types of commonly used gaskets: metallic gaskets and soft gaskets. While these gaskets both have many advantages, they are complete opposites in many ways also. The traditional soft gaskets (PTFE, graphite, compressed non-asbestos, elastomer, etc.) seal at a very low stress and typically do not risk yielding the bolts in the connection. However, the soft PTFE material is vulnerable to blow outs because of its lower tensile strength and its propensity to relax, or lose bolt load, in service. The traditional hard metallic gasket is extremely blowout resistant because of its high strength, metallic construction. However, these metal gaskets (spiral wound, double jacketed, solid metal, etc.) can require from three to five times the amount of stress needed to seal compared to a soft PTFE gasket. Some flanges cannot handle the amount of stress needed to compress and seat metallic gaskets nor, in many cases, is there sufficient bolt load available to develop this required gasket stress. There are many flange styles and types that are unsuitable for these high bolt loads and using metallic gaskets to guard against blow-out failures in these connections can put the bolts in the connection at risk for permanent deformation.

### SUMMARY

Accordingly, it is an object of the present invention to overcome the foregoing blow out concerns with respect to gaskets and provide a blow-out resistant gasket suitable for use in many/all flange types; especially those where metal gaskets cannot be used. Specifically, a gasket as described herein includes a tanged metal core with soft outer facing layers configured on either side of the tanged core.

In one example, a composite gasket includes a hard material core layer and two soft outer layers positioned on opposite sides of the hard material core layer. The core layer comprises a tanged sheet comprising at least ten tangs per square inch of the surface of the tanged sheet. The material that comprises the core layer is harder than the material that comprises the outer layers. In one example, the composite gasket comprises no adhesive between the core layer and the outer layers. The core layer may be made of metal or, alternatively, stainless steel. The core layer tanged sheet may comprise about 20 to 50 tangs per square inch. The outer layers may be comprised of a compressible material selected from the group consisting of PTFE, compressed non-asbestos, and elastomers. The tangs may comprise a tang height of between 0.025 to 0.1 inches. Alternatively, the tang height may be approximately 30% to 90% of the thickness of the outer layers. The gasket may be precompressed during manufacturing so that the tangs extend and pierce into but do not cut all the way through the thickness of the outer layers.

### BRIEF DESCRIPTION OF THE DRAWINGS

FIG. 1 is a top view of a composite gasket as described herein with half of the outer facing removed.

FIG. 2 is a perspective view of the composite gasket shown in FIG. 1 with a part of the outer layer lifted.

FIG. 3 is a side cross-sectional view of the core layer of the composite gasket described herein.

FIG. 4 is a side view of the composite gasket.

FIGS. 5A and 5B are perspective views of the composite gasket partially compressed, FIG. 5A, and fully compressed, FIG. 5B.

FIG. 6 is a relaxation text comparing an example of the gasket described herein with a prior art gasket material.

FIG. 7 is a deflection curve graph relating to an example of the gasket described herein.

FIG. 8 is an HOBT2 (Hot Blowout) test curve relating to the gasket described herein.

FIG. 9 is an HOBT2 test of barium sulfate filled PTFE.

FIG. 10 is an HOBT2 test graph relating to the gasket described herein.

### DETAILED DESCRIPTION

The composite gasket described herein incorporates the advantages of both soft PTFE and hard metallic gaskets. The gasket includes soft, conformable, and relaxation resistant outer layers that do not require high bolt loads to seal. However, the composite gasket also includes a hard core so that the gasket will be extremely blow out resistant.

The term “tang” or “tanged” is used throughout this discussion. For the purposes of this application, a tang is a relatively hard shape or protrusion that extends outwardly from the otherwise flat surface of a sheet of hard material, wherein the shape or protrusion is adapted to pierce into a softer material resulting in a mechanical grip between the tang sheet and the material. The tang protrusion is typically formed from a metallic sheet. A continuous, flat metal sheet is punctured with a die or other tool to create an aperture in the metal sheet. The punch pushes the metal material away from the sheet in an outward direction. As a result of the mechanical action of the punch, the displaced metal material is often jagged, sharp and uneven. In some examples, the protrusion of the tang extends in a direction that is substantially perpendicular to the plane of the metal sheet that is being tanged. The protrusion of the displaced metal material may be reasonably and is often less than perpendicular to the surface of the metal material. Accordingly, the aperture or opening that is created in the metal sheet is related to the height of the tang protrusion that is formed. In other words, the height of the tang is typically less than half of the largest diameter of the aperture that is created. In any event, the height of the tang is no larger than the longest diameter of the aperture that is created as the material is pushed from that sheet. Accordingly, for the purposes of this disclosure, the term “tang” includes both the tang protrusions and the tang apertures created in the hard sheet material. And the tangs are present on both sides of the core material.

The composite gasket construction consists of soft outer facing layers with a harder tanged material sandwiched in between. The soft outer facings allow the gasket to conform to flange irregularities while also sealing at low bolt loads. Upon compression in a flange, the tangs spear further into the body of the facing layers allowing the harder tanged core to securely grip into the outer facings and thus provide a stable core throughout the entire body of the gasket that is highly blow out resistant.

In one example, the composite gasket construction is expanded PTFE (ePTFE) outer facings with a stainless steel tanged core. The ePTFE is chemically inert, has high tensile strength, and has increased resistance to relaxation compared to other forms of PTFE gasketing. The ePTFE is compatible with many gasket applications in the industry, has a service temperature range of less than 450° F. to more than 600° F. (−268° C. to +315° C.,) and is pH 0-14 compatible with a density between 0.2 to 1.2 g/cm3. Each facing layer, prior to compression, is typically 0.078 inches thick with a range of 0.062 to 0.125 inches for standard applications, and 0.031 to 0.250 inches for custom applications. Additional industry standard outer facing materials will also include microcellular PTFE, porous PTFE, filled PTFE and many commonly used elastomers.

A stainless steel, tanged core is also compatible with many applications and services in the industry. In one example, the tanged core thickness is 0.005 inches with the multidirectional tangs protruding to an overall height of 0.080 inches. The tang height of 0.04 inches is optimal for gripping into the softer outer facings and proving a bolted flange connection without any adhesives. The metal sheet will have a thickness ranging from 0.002 to 0.031 inches. The individual tangs will range in height between 0.025 to 0.1 inches. The height of the individual metal tangs should be about 50% of the individual, initial outer facing layer thickness, or alternatively approximately 30 to 90% of the outer facing layer thickness.

One of the advantages of the present composite gasket technology is that there is no glue or adhesives used in the manufacturing process. Glue layers in gaskets have proven to result in lower blow out resistance as the glue softens at elevated temperatures and forms a lubricious boundary layer. Existing tanged reinforced graphite technology does not utilize the optimum specifications for a tanged core. The current tanged reinforced graphite gasket uses thick graphite sheet outer layers with low profile tangs, for example 0.018 inches to 0.022 inches, that require adhesive to grip to those graphite outer facings. The use of adhesives also create issues/concerns with purity and potential chemical attack of the adhesive layer resulting in leakage.

The bond between the tanged core and the outer facing layers is an important component of the present composite gasket technology. The heights of the tangs that protrude from the metal core are carefully designed to ensure that they spear through about 90%, or alternatively about 60% to 95%, of the ePTFE facings when installed and compressed in an application. The tangs fold over upon themselves yet do not pierce the surface of the ePTFE, creating a metal/ePTFE matrix within the body of the gasket thus providing superior mechanical strength and blow out resistance. This bond may be controlled by the amount of pre-compression a composite gasket receives during the manufacturing process. The gasket may be compressed so that the tangs pierce through the ePTFE at about 30%, which is enough to provide the mechanical grip so that glue is not required. If under-compressed, for example less than 30% penetration into the ePTFE facings during manufacturing, the bond will not be strong enough to maintain the gasket construction. If over-compressed, for example greater than 90% penetration into the ePTFE facings during manufacturing, the expanded PTFE densifies outside of its preferred density range.

It has been determined in one example that pre-compressing a gasket to an overall thickness of 0.125 inches, from 0.170 inches, is optimal for nearly all of applications currently in the industry. For custom applications requiring varying thicknesses, the pre-compression can range between 0.062 to 0.140 inches while still maintaining a sufficient bond.

The composite gasket technology may be formed in ANSI standard pipe flange sizes as well as any custom shapes. The composite gasket may be manufactured as a 60″×60″ sheet making it possible to cut any desired shape from the material. The only limitation is that the gasket must have a cross section of at least about 0.250 inches, or alternatively about 0.125 inches to 0.375 inches. The availability of a highly blow-out resistant gasket fabricated in any shape, size, or geometry from a sheet material is very advantageous as metallic gaskets used for this purpose require specific manufacturing equipment and are not readily available and are limited in shape.

In the foregoing examples, the core disk is made of stainless steel. Other metals may be used with their selection including compatibility with a given service location. Additionally, however, other hard materials may be used as the core material. These materials include rigid polymers, ceramics, and other composite materials and laminations thereof. Since stainless steel has favorable chemical properties as well as mechanical strength, it is typically the preferred core material.

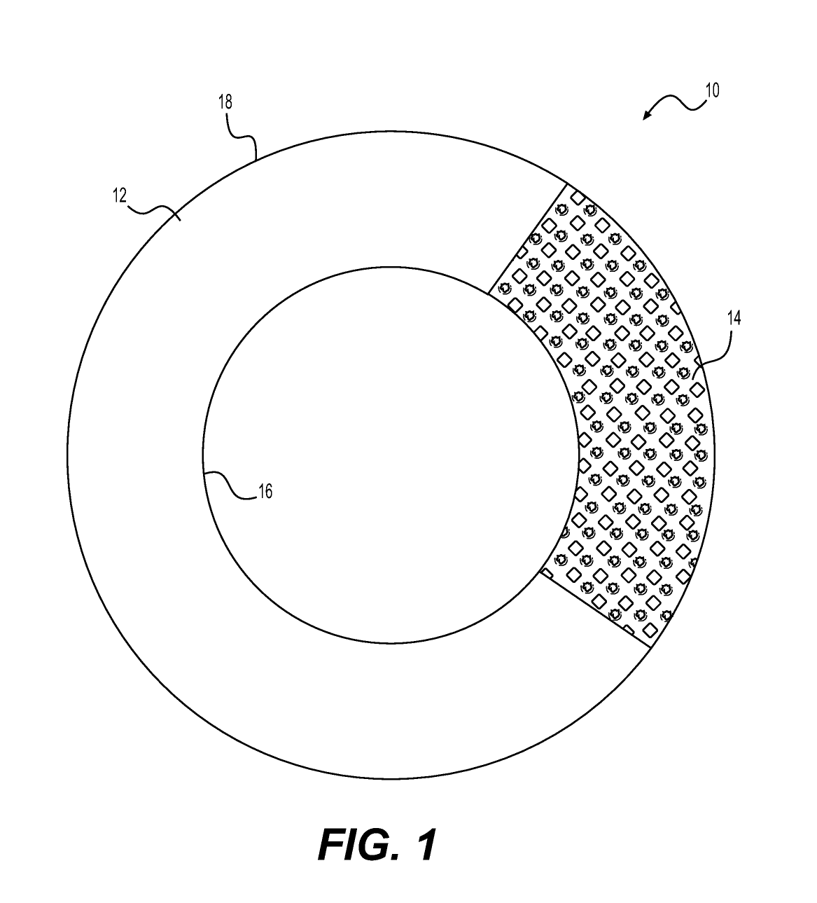

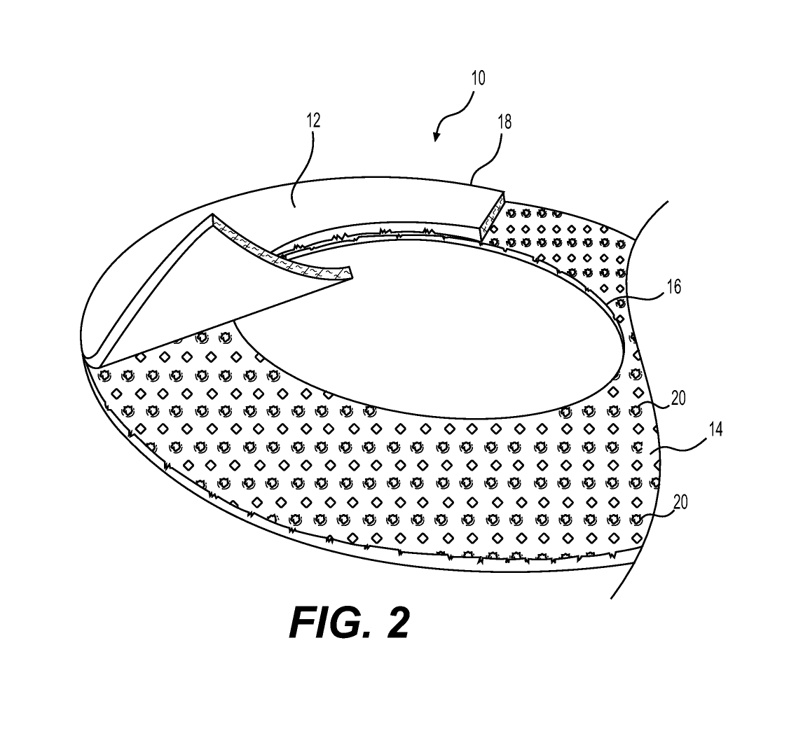

Referring now to the drawings, FIGS. 1 and 2 display a partial composite gasket 10. Specifically, there is shown half of a soft outer facing layer 12 configured onto the tanged metal core disk 14. The soft outer facing layer 12 would of course extend all around and cover the tanged core 14. Half of the soft outer facing layer 12 is shown removed for purposes of illustration. The gasket 10 is defined by an inside diameter 16 and an outside diameter 18.

In FIG. 2, the tanged core 14 more clearly displays the tangs 20. In order to create a reasonable bond between the core 14 and the outer facing layers 12, there should be at least ten tangs 20 per square inch of the metal core 14. Alternatively, there may be 12 to 50 tangs per square inch in order to more aggressively secure a tanged core 14 to soft outer layers 12.

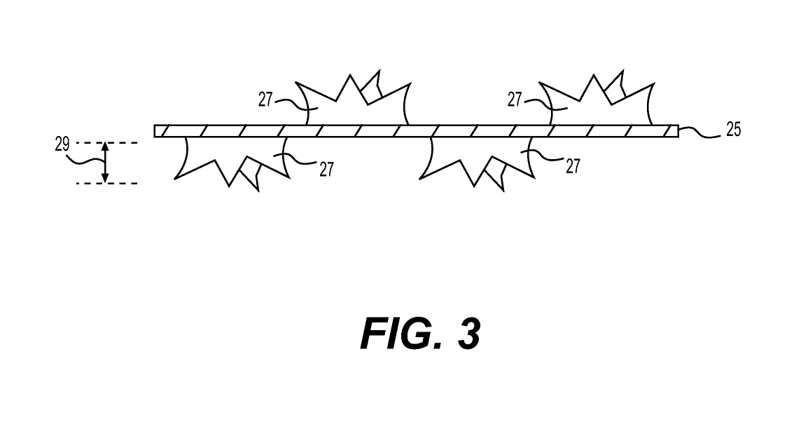

FIG. 3 illustrates an example of a hard tanged core 25. The core material 25 includes both upwardly facing and downwardly facing tangs 27. The height of those tangs 29 is shown. Naturally, the height of each individual tang may vary depending on how the flat sheet of hard material is pierced to form and create the tangs. Typically, a tang sheet has approximately an equal number of tangs facing in each direction. It is possible that there would be more tangs facing in one direction than another if called for under certain conditions.

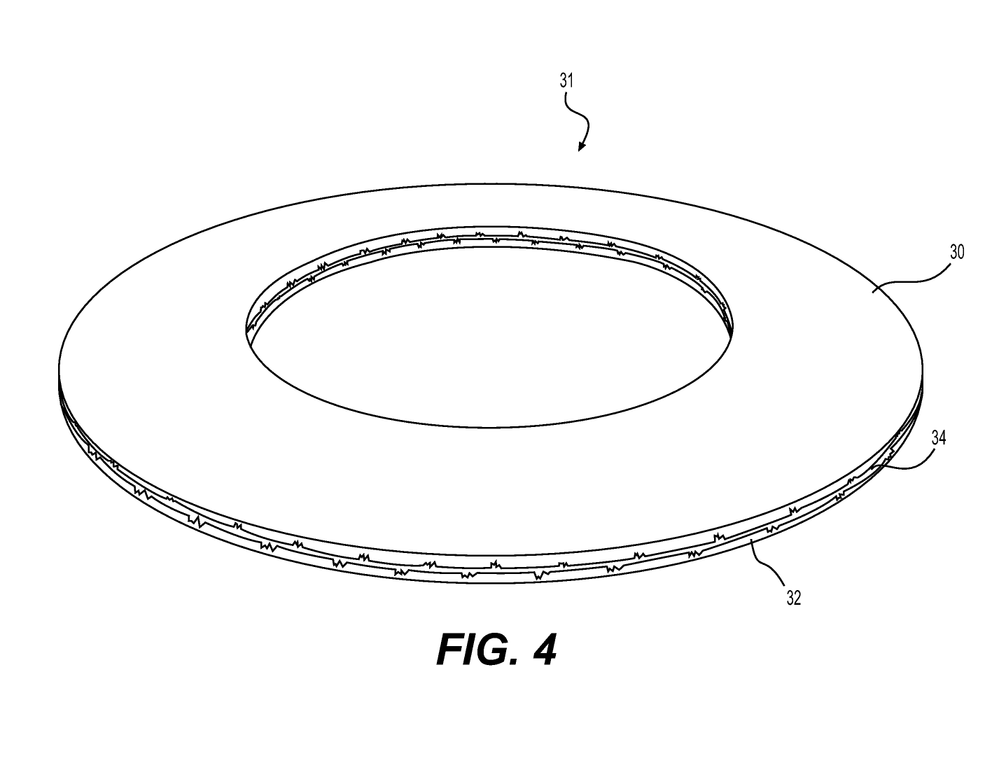

FIG. 4 demonstrates a side view of a gasket 31 having an upper facing layer 30 and a lower facing layer 32 on either side of the tanged core 34.

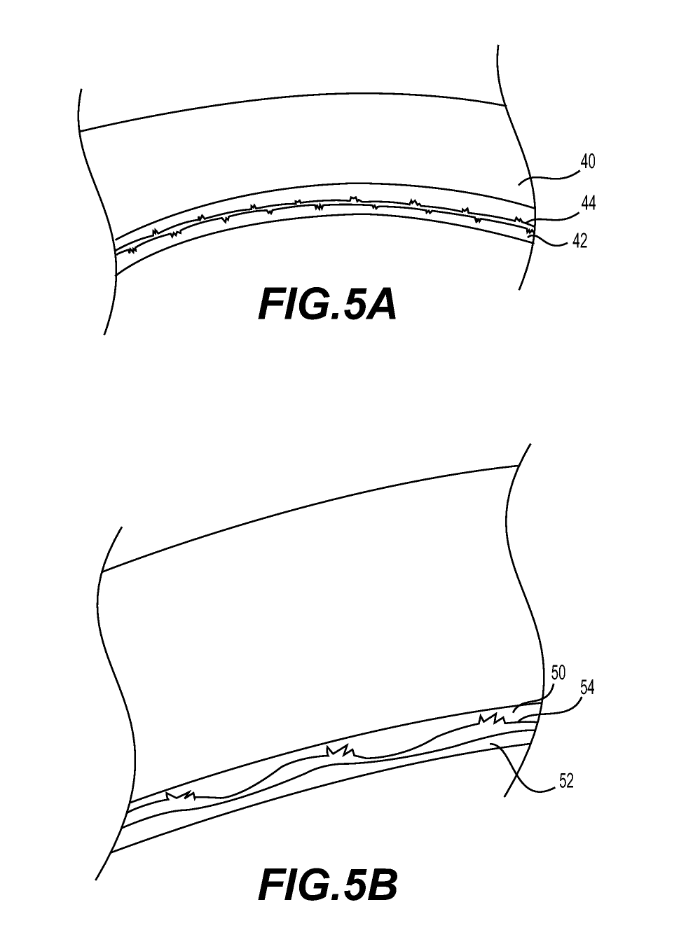

FIGS. 5A and 5B are close-up views of a composite gasket. In FIG. 5A, the top soft facing layer 40 and bottom soft facing layer 42 are shown in their post manufactured, prior to flange assembly, thick, uncompressed state around the tanged core 44 also post manufactured, prior to flange compression. In FIG. 5B, the composite gasket has been compressed so that the top facing layer 50 and bottom facing layer 52 are not as thick as shown in FIG. 5A.

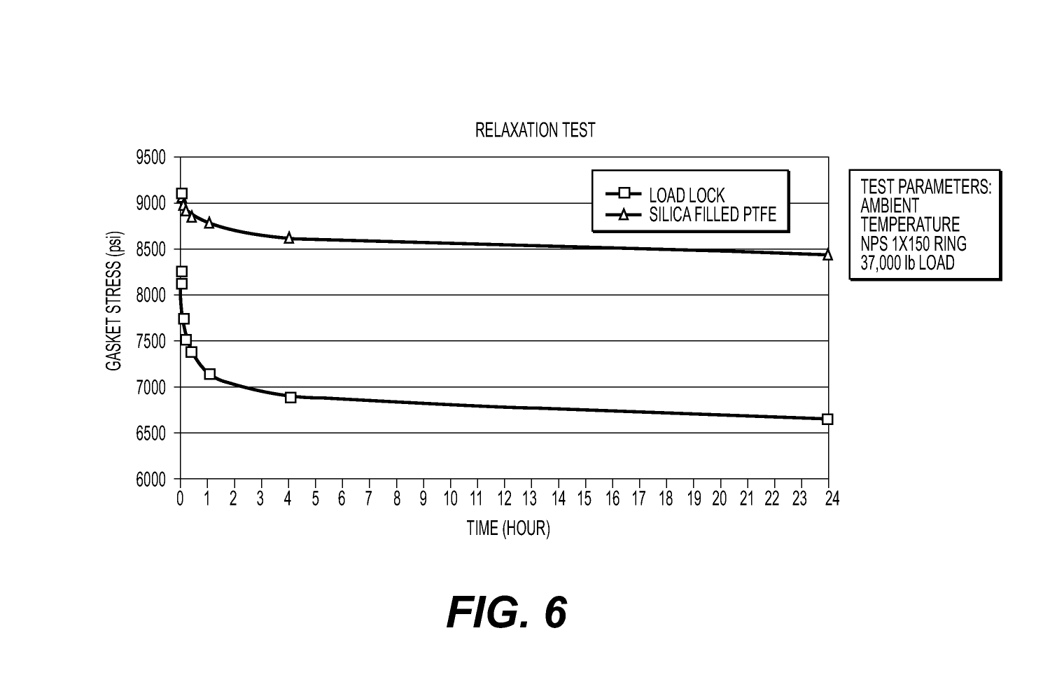

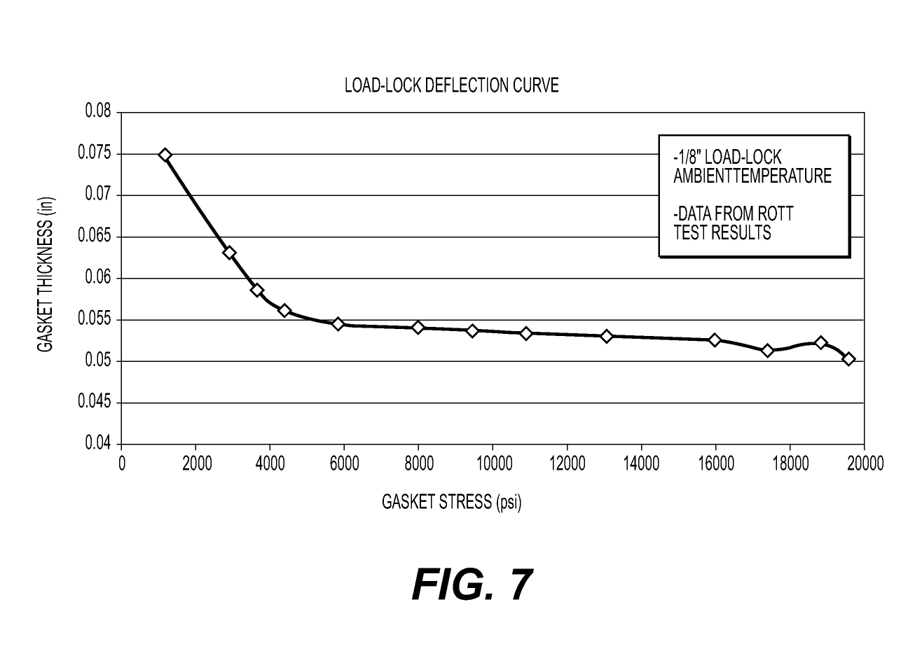

Testing has been performed on the composite gasket. FIG. 6 shows a composite gasket performance compared to other commonly used PTFE gasketing material in the industry. In the testing shown in FIG. 6, the composite gasket was formed of 2 mm thick ePTFE facing layers mechanically (i.e. controlled manufacturing compression on both sides of a 0.005 inches tanged SS foil with 0.040 inches protruding tangs on each side of the foil). This is the same composite gasket as tested and shown in FIGS. 7-10. The tanged, core construction is very effective in maintaining stress on the gasket and provides marked improvements compared to other PTFE gasket materials including the silica-filled PTFE shown in FIG. 6 which heretofore is considered a highly creep and blow-out resistant PTFE gasket material. The tanged core, nearly protruding through the ePTFE facings helps support the compressive load, thus dramatically reducing the load/stress lost by the PTFE itself. This type of data is extremely valuable because there is a much higher blow out potential when using a gasket that has high relaxation properties, and thus maintains a higher compressive load on the gasket when in service.

FIG. 7 shows the overall gasket thickness as stress was increased. This data in FIG. 7 indicates that the gasket thickness bottoms out at around 0.05 inches regardless of how much stress is added. This proves that the composite gasket material is highly cut-through resistant, and compresses into a sealing/mechanical shim at a certain level of compression. Again due to the mechanical/load support provided by the metal tangs. This compression stability protects against additional in-service gasket compression due to cyclical thermal and stress loads, resulting in higher maintained bolt loads in service at elevated temperatures, and also confirms the ePTFE/stainless steel matrix within the body of the gasket.

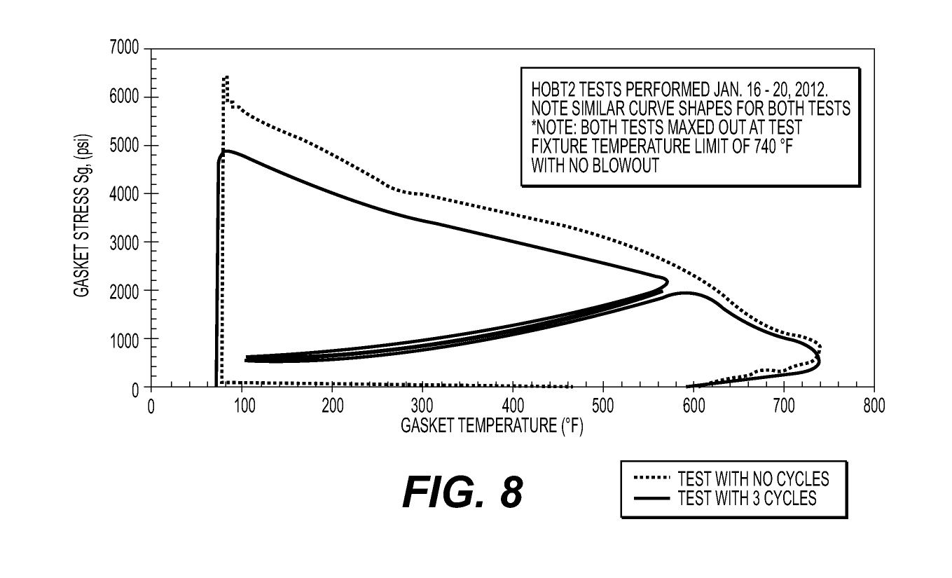

FIG. 8 shows blow out testing performed on the composite gasket material. During the test, the temperature is cycled three times between 100° F. and 600° F. and then increased at a steady rate either until blow-out occurs or the fixture reaches its maximum temperature limit of 740 F. This testing shows how the gasket thickness is very stable and does not “ratchet” under temperature and stress cycling. Ideally, a gasket stress trend should be the exact same during each temperature cycle. The composite gasket displays this property because the thick black line is actually the three separate trends almost completely on top of each other. Also, the temperature maxed out at 740° F. and a blow out never occurred. Additionally there was no noticeable difference in the temperature stress reduction response during any of the cycles even compared to the test performed with no cycling. These are all desirable, measurable properties of a blow-out resistant gasket.

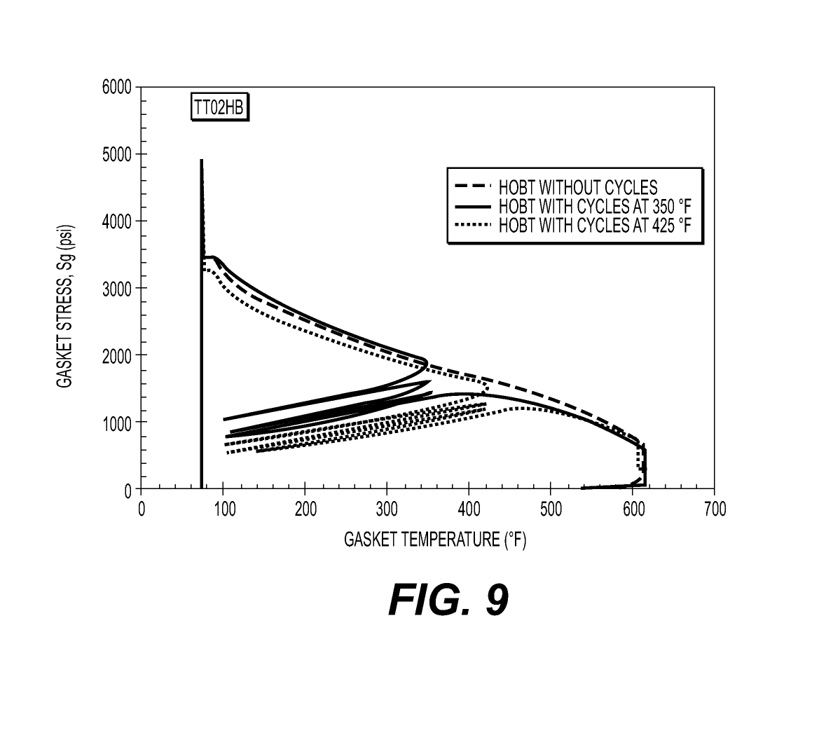

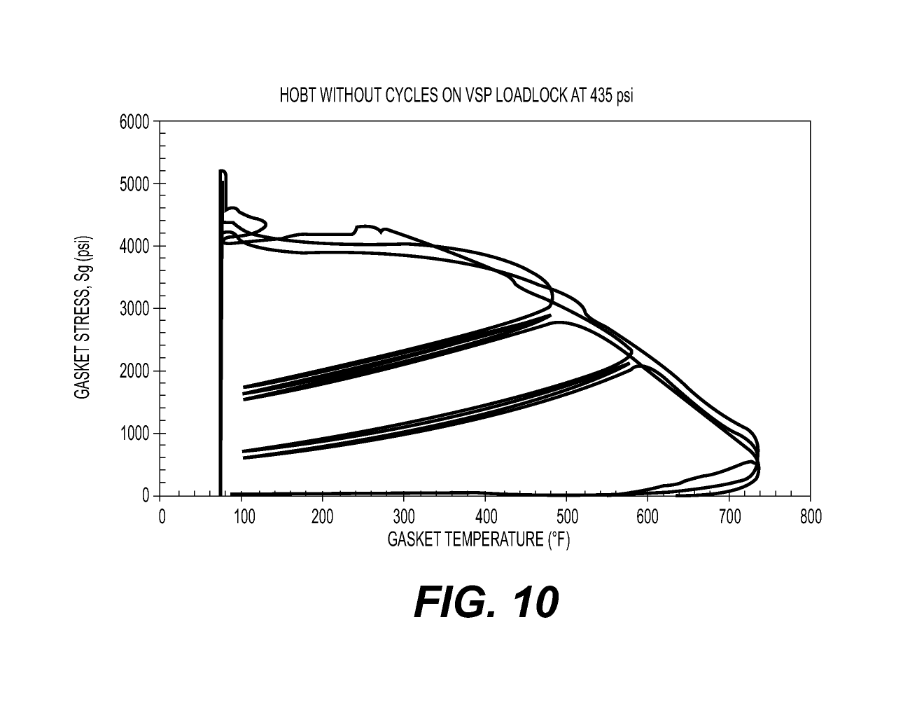

The portion of the composite gasket curves before the thermal cycling temperatures in FIG. 10 are much flatter than those of the filled PTFE gasket curves in FIG. 9, indicating greater thermal stability, less relaxation response to temperature, and subsequent improved blow-out resistance. Referring again to FIG. 9, the filled PTFE materials tested all experience a blow-out failure at 600 F; indicating worse blow-out performance than the composite gasket which still did not blow out at the maximum test temperature of 740 F.

| | Initial Ambient | Residual Stress | Residual Stress | Residual Stress |
|---|---|---|---|---|
| | Temp. Stress | At 200 F. | At 300 F. | At 500 F. |
| Material | Applied To Gasket | (% relaxation) | (% relaxation) | (% relaxation) |
| Filled PTFE | 5,000 psi | 2,500 psi (50%) | 2,000 psi (60%) | 1,200 psi (76%) |
| Composite | 5,000 psi | 4,200 psi (16%) | 4,000 psi (20%) | 3,000 psi (40%) |

In house and third party testing has proven that other commonly used filled materials show considerable hysteresis with the cycling curves because they are “ratcheting” and compressing/expanding during subsequent stress and thermal cycles. These gaskets exhibit stress loss as a result, which in turn leads to decreased blow-out resistance at elevated temperatures.

The composite gasket technology described herein will fill a product gap currently in the bolted flange connection industry. It combines the advantages of both PTFE (or soft) gaskets and hard metallic gaskets. Most importantly, introducing this composite gasket technology will reduce the number of blow outs and dangerous leaks in the process industry.

Other embodiments of the present invention will be apparent to those skilled in the art from consideration of the specification. It is intended that the specification and figures be considered as exemplary only, with a true scope and spirit of the invention being indicated by the following claims.

That which is claimed is:

1. A composite gasket comprising a hard material core layer and two soft outer layers positioned on opposite sides of the hard material core layer;
wherein the core layer comprises a tanged sheet comprising at least 10 tangs per square inch of the surface of the tanged sheet, and further wherein the material that comprises the core layer is harder than the material that comprises the outer layers.

2. A composite gasket as described in claim 1, wherein the composite gasket comprises no adhesive between the core layer and the outer layers.

3. A composite gasket as described in claim 1, wherein the composite gasket comprises a core layer of metal.

4. A composite gasket as described in claim 1, wherein the composite gasket comprises a core layer of stainless steel.

5. A composite gasket as described in claim 1, wherein the core layer tanged sheet comprises about 20 to 50 tangs per square inch.

6. A composite gasket as described in claim 1, wherein the outer layers are comprised of a compressible material selected from the group consisting of PTFE, compressed non-asbestos, and elastomers.

7. A composite gasket as described in claim 1, wherein the tangs comprise a tang height of between about 0.025 to 0.1 inches.

8. A composite gasket as described in claim 1, wherein the outer layers each define a thickness, and the tang height is approximately 30% to 90% of the outer layers thickness.

9. A composite gasket as described in claim 1, wherein the outer layers each define a thickness, and the tang height is approximately 50% of the outer layer thickness.

10. A composite gasket as described in claim 3, wherein the metal core layer thickness is from about 0.002 to 0.031 inches.

11. A composite gasket as described in claim 1, wherein the core layer is a tanged stainless steel sheet and the outer layers are expanded PTFE.

12. A composite gasket as described in claim 11, wherein the gasket is pre-compressed so that the tangs extend into but do not cut all the way through the thickness of the outer layers.
